(19) United States
(12) Patent Application Publication
(10) Pub. No.: US 2008/0172774 A1
(43) Pub. Date: Jul. 24, 2008

(54) METHOD TO PRODUCE IN-MOULD HELMETS AND IN-MOULD HELMETS ACCORDING TO THE METHOD

(75) Inventors: Stefan Ytterborn, Saltsjobaden (SE); Jan Woxing, Saltsjobaden (SE)

Correspondence Address: MORRISON & FOERSTER LLP, 425 MARKET STREET, SAN FRANCISCO, CA, 94105-2482, US

(73) Assignee: POC Sweden AB, Saltsjobaden (SE)

(21) Appl. No.: 11/972,572

(22) Filed: Jan. 10, 2008

Related U.S. Application Data
(60) Provisional application No. 60/880,099, filed on Jan. 12, 2007.

(51) Int. Cl. A42B 3/06; A42B 3/12; B29C 49/02

(52) U.S. Cl. 2/412; 2/411; 2/2.5; 264/257

(57) ABSTRACT

The invention concerns an in-mould helmet, comprising a shell (1) and a blow-moulded layer of shock absorbing material (2) inside the shell. The in-mould helmet is provided with penetration protection (3), at least partially, between the shell (1) and the shock absorbing layer (2). The invention also concerns a method to produce an in-mould helmet, comprising the steps of
vacuum forming a shell (1),
arranging penetration protection (3) inside the shell (1), and
blow-moulding shock absorbing material (2) inside the shell (1).

### CROSS REFERENCE TO RELATED APPLICATIONS

This application claims the benefit under 35 USC 119(e) of U.S. Provisional Application Ser. No. 60/880,099, filed Jan. 12, 2007, the contents of which are hereby incorporated by reference in the present disclosure in their entirety.

The present invention concerns a light weight, safe in-mould helmet and a method of producing such a helmet.

### BACKGROUND ART

When designing a helmet certain safety factors are taken into account, such as energy absorbing, penetration and weight.

There are two main types of helmets on the market-in-mould helmets and hard shell helmets.

In-mould helmets are produced by forming a sheet of, for example, polycarbonate by vacuum forming it into a thin shell and then blow mould energy absorbing material, such as EPS, into the shell by blow-mould technique. The thin shell is not fibre reinforced. In this way, an extremely lightweight helmet is accomplished. This type of helmet is widely used in the areas of bicycling, skateboarding and in the use of roller blades and the like.

Hard shell helmets differs radically from in-mould helmets, since hard shell helmets are built up by an outer hard shell of thicker, polymer material, normally with a thickness in the range of 2-3.5 mm. Sometimes the outer shell is reinforced with laminated glass or carbon fibres. Hard shell helmets are produced in a more time and labour consuming way since firstly a hard shell is manufactured, which thereafter may be reinforced with, for example, a layer of glass fibre laminated to the inside of the helmet. Secondly an inner shock absorbing part is produced. Thirdly the inner part is mounted inside the hard shell. And then cushioning and the like usually are applied to the inside. This type of helmet is widely used in the areas of motorcycling, skiing and the like with tougher requirements.

An advantage with the in-mould helmet is that when it is exposed to a shock or a hit the thin shell collapses in order to absorb and spread shock energy. A disadvantage of having a thin shell is that it cannot withstand penetration as well as for example a shell of a hard shell helmet. But a hard shell in turn has poor energy absorbing qualities and shows problems with bouncing.

There is a European helmet standard for helmets used in alpine sports, namely EN 1077. In-mould helmets usually do not qualify to this standard due to poor performance in penetration safety. In general hard shell helmets qualify for this standard. There is another helmet standard for helmets for pedal cyclists and users of skateboards and roller skates, namely EN 1078. The main difference between the two standards is the enhanced penetration safety requirements of EN 1077.

### SUMMARY OF THE INVENTION

The object of the invention is to provide and produce, in a time and cost effective way, a lightweight but still safe helmet for use in alpine sports and the like, for example according to the standard 1077.

The present object is met by a helmet according to claim 1 and a method to produce such a helmet according to claim 6.

The essence of the invention is to strengthen the penetration safety by means of arranging penetration protection between the shell and the shock absorbing layer. The penetration protection is preferably a net or a woven or nonwoven material in the helmet, which is designed to catch any object that may penetrate the shell of the helmet and prevent that the object penetrates further through an inner portion of shock absorbing material of the helmet.

Preferably the net or woven or nonwoven material extends over the whole area of the helmet. The net or woven or nonwoven material may preferably be of unlaminated and/or unhardened fibres of, for example, glass, carbon or aramid. The net may, for example, be woven but preferably connected at its nodes by means of knots, glue or something else.

Thus a light helmet with enhanced penetration safety can be achieved, which will reduce neck injuries, for example. The inventive helmet will also in a high degree absorb shock energy due to partial collapsing of the shell in an accident. Due to the partial collapsing of the shell bouncing of the helmet against the hit surface is reduced or even prevented.

The penetration protection is not laminated or fixed to the inside of the shell so firmly that the shell acts like a fibre reinforced shell, which is often done in hard-shell helmets in order to strengthen the shell. Laminating or fixing fibres to the shell will give a hard shell that bounces. In the present invention the shell is intended to absorb at least a portion of the shock energy by partial collapsing instead. A person skilled in the art may easily test how firm the fixing of the fibres to the inside of the shell can be without loosing the effect of the invention.

The thin shell may have a thickness of 0.01-4 mm, preferably 0.1-1.0 mm, especially if the material of the thin shell is for example abs, polycarbonate, lexan or other thermo plastic materials. Other materials are also conceivable, which might be lighter but then need a thicker shell. The thin shell is preferably not fibre reinforced. The shock absorbing layer may be made of expanded polystyrene (EPS) or expanded polypropylene (EPP) or alike materials.

The inventive in-mould helmet with enhanced penetration safety may be produced by vacuum forming a shell, arranging penetration protection inside the shell, and blow-moulding shock absorbing material inside the shell.

This results in an in-mould helmet having a penetration preventing effect in addition to the general advantages of the low weight, good energy absorbing properties and the effective production of an in-mould helmet.

### SHORT DESCRIPTION OF THE DRAWINGS

The present invention will now be described by means of a preferred embodiment under referral to enclosed drawings, in which:

FIG. 1 shows an in-mould helmet according to a preferred embodiment of the present invention in cross section.

### DETAILED DESCRIPTION OF PREFERRED EMBODIMENTS OF THE INVENTION

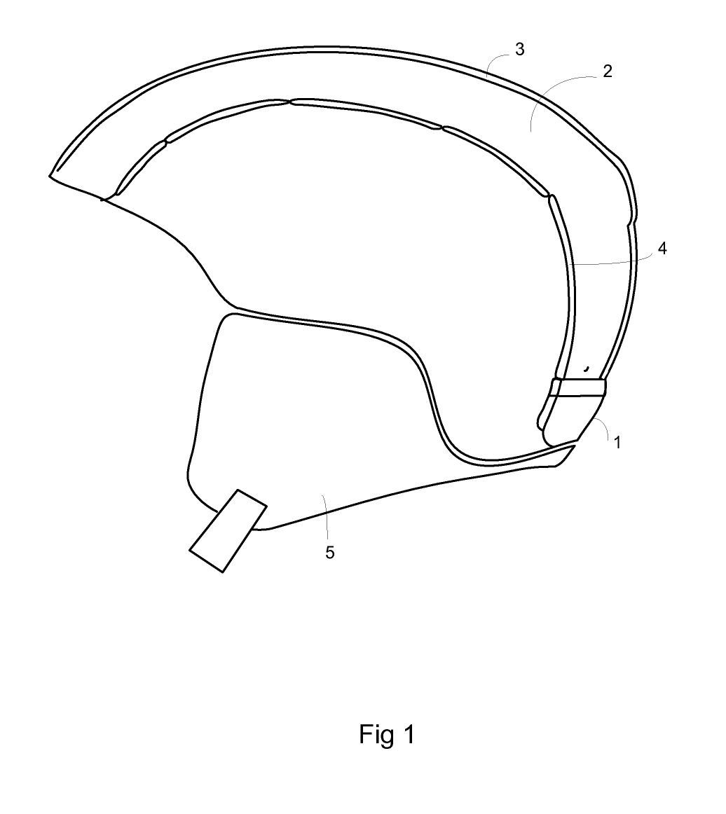

In FIG. 1 an in-mould helmet according to a preferred embodiment of the invention is shown in cross section. It comprises a shell 1, a shock absorbing layer 2 and a penetration protection 3 arranged in between the shell 1 and the shock absorbing layer 2. The in-mould helmet may also be provided with comfort padding 4 and some kind of fastening means 5, in the shown FIGURE, ear cover and chin strap.

The penetration protection 3 may cover the whole inside of the shell 1 or be arranged in one or more portions, for example in especially exposed areas. The penetration protection 3 is preferably a net or woven or nonwoven material.

The net or woven or nonwoven material is preferably made of aramid fibres, preferably unlaminated/unhardened fibres. This material is preferably drapable, ie flexible over a double curved surface. The fibres are not locked in relation to each other before attachment inside the shell 1. But in the production of the helmet during the step of blow moulding the shock absorbing layer 2 into the shell 1 of the helmet the fibres will be stabilized in a final position for the fibres inside the shell 1 by means of the shock absorbing material 2. In the case a net is used it may, for example, be woven but preferably connected at its nodes by means of knots, glue or something else.

When the net or woven or nonwoven material is applied in this way it will catch and prevent any sharp objects from penetrating deep into the shock absorbing layer 2. Thus, the same thin shell 1 can be used as in an in-mould helmet of known art but with much better penetration safety.

The shell 1 is preferably made of abs, polycarbonate or lexan, although other materials, such as thermo polymers, are conceivable. The thickness of the shell material is in the range of 0.01-4 mm and preferably in the range of 0.1-1 mm. The thin shell 1 is not fibre reinforced.

When the in-mould helmet is exposed to a shock or a hit the shell 1 shall collapse in order to absorb and spread shock energy. Thus, bouncing of the helmet is also prevented. These features are achieved due to the thin shell.

The shock absorbing layer is preferably made of EPS, expended polystyrene or EPP, expanded polypropylene. In order to achieve good energy absorbing characteristics the density of the EPS or EPP should be as low as possible. In this way a slower deceleration of any objects is achieved and more shock energy will be absorbed. But the penetration prevention diminishes with decreasing density. Therefore a balance between the density and the thickness of the shock absorbing layer must be found. For example, a thickness of the EPS layer in the range of 10-30 mm and density of the EPS in the range of 60-95 kg/m³ is suitable.

### Method for Producing a Preferred Embodiment

The thin shell 1 is vacuum formed into desired shape; the net, woven or nonwoven fibre cloth 3 is attached inside the vacuum formed shell 1; the shell 1 with the attached net, woven or nonwoven fibre cloth 3 is placed in a female part of a form; a male part of the form is positioned in the form and spheres of EPS or EPP is blown into the form and thus into the inside of the shell 1 with the attached net or cloth 3. Hot gas is used to make the spheres of EPS or EPP to expand further and attach to each other and thus form an inner layer of shock absorbing material 2. Thereafter the helmet is cooled down.

1. An in-mould helmet, comprising a shell (1) and a blow-moulded layer of shock absorbing material (2) inside the shell (1), wherein the in-mould helmet is provided with penetration protection (3), at least partially, between the shell (1) and the shock absorbing layer (2).

2. The in-mould helmet of claim 1, wherein the penetration protection (3) is a net or a woven or nonwoven cloth.

3. The in-mould helmet of claim 1, wherein the penetration protection (3) comprises aramid fibres.

4. The in-mould helmet of claim 1, wherein the shell (1) comprises polycarbonate.

5. The in-mould helmet of claim 1, wherein the shock absorbing layer (2) comprises expanded polystyrene.

6. A method to produce the in-mould helmet of claim 1, the method comprising the steps of
vacuum forming the shell (1),
arranging the penetration protection (3) inside the shell (1), and
blow-moulding the layer of shock absorbing material (2) inside the shell (1).

7. The in-mould helmet of claim 2, wherein the net or the woven or nonwoven cloth comprises aramid fibres.

8. The method of claim 6, wherein the penetration protection (3) is a net or a woven or nonwoven cloth.

9. The method of claim 6, wherein the penetration protection (3) comprises aramid fibres.

10. The method of claim 6, wherein the shell (1) comprises polycarbonate.

11. The method of claim 6, wherein the shock absorbing layer (2) comprises expanded polystyrene.
